(19) United States
(12) Patent Application Publication
(10) Pub. No.: US 2010/0024950 A1
(43) Pub. Date: Feb. 4, 2010

(54) METHOD FOR ARMOURING A WINDOW

(75) Inventors: Johannes Pieter Frans Broos, 's Gravenzande (NL); Erik Peter Carton, Den Haag (NL)

Correspondence Address: LUCAS & MERCANTI, LLP, 475 PARK AVENUE SOUTH, 15TH FLOOR, NEW YORK, NY, 10016, US

(73) Assignee: Nederlandse Organisatie voor toegepast-natuurweten schappelijk onderzoek TNO, Delft (NL)

(21) Appl. No.: 12/447,208

(22) PCT Filed: Oct. 26, 2007
(86) PCT No.: PCT/NL2007/050516

§ 371 Date: Jun. 30, 2009

(30) Foreign Application Priority Data
Oct. 27, 2006 (EP) 06076943.7

(51) Int. Cl. B32B 37/12; B05D 5/06

(52) U.S. Cl. 156/60; 427/164

(57) ABSTRACT

The invention relates to a method for armouring a window of an existing object comprising applying a transparent polymer layer to a surface of the window. The layer is usually applied to a surface facing the inside of the object. In particular, the invention may be employed to a conventional glazing of a building or vehicle.

The invention relates to a method for armouring a window of an existing object.

Transparent armour materials with antiballistic properties are usually made of multiple layers of transparent material having a hard frangible flat face plate backed by one or more transparent tough resilient plates, bonded together by a suitable transparent adhesive. Such armour is for instance described in United States Statutory Invention Registration H1567 (application number 667,624). Another laminated transparent armour is described in United States Statutory Invention Registration H1519 (application number 522,788).

In the art windows with an antiballistic function comprise a special glass, having a high resistance against high velocity impact against bullets and/or other missiles.

The use of special glasses is expensive. Also, armour glass plates are usually flat as these tend to be difficult to shape in curved forms, for practical reasons. Further, these glasses tend to have a large thickness, which makes windows composed thereof heavy. This may require special measures to be taken in order to support the window in the object, e.g. fortification of hinges, grooves or the frame. This may further increase the weight of the object.

Furthermore, in order to protect windows in an existing object against the impact of a projectile such as a bullet, it is not only expensive but also laborious to have to replace existing windows with such material. Further, it is practically impossible to shoot from the protected side of the window.

It is an object of the present invention to provide a novel method for armouring a window of an object.

It is in particular an object to provide a method that can overcome one or more of the above identified drawbacks.

One or more objects which may be solved in accordance with the invention may be derived from the description herein below.

The inventors have realised that it is possible to improve an antiballistic property of a window in an existing object, in particular a window, such as ordinary windowpane or ordinary car glass. They have further realised that this is possible by in situ applying a layer of a specific material to the window.

Accordingly, the present invention relates to a method for armouring a window of an existing object comprising applying a transparent polymer layer to a surface of the window.

In particular, the present invention relates to a method for armouring a window of an existing object comprising applying a transparent polymer layer to a surface of the window, said polymer layer having a thickness of at least 5 mm and a strength of at least 2 MPa.

In particular, the transparent polymer layer is applied to a surface of the window opposite to the surface from which a ballistic threat can generally be expected. Accordingly, usually an inner surface of the window in the object is provided with the polymer layer. In an embodiment, it is advantageous that the invention allows a subject inside the object, who is protected by the window, to shoot through the window, whilst maintaining some level of protection, as a bullet shot by the subject first penetrates through the polymer and thereafter through the glass. On the other hand, a bullet or the like impacting the window from the other side will generally be stopped by the armoured window.

The glass and the polymer layer may act synergistically with respect to an antiballistic property. It is contemplated that the polymer allows the glass to have a better antiballistic performance. The polymer layer supports and/or strengthen the glass. Thus the anti-ballistic protection provided by the glass is improved, also if polymer layer and/or the glass as such do not show a considerable ballistic protection.

In particular multi-hit capacity and/or the protection against a detrimental effect of a blast (from an explosion), such as ejection of window fragments, may be improved by providing a transparent polymer layer to a surface of a window. Accordingly, the invention also relates to the use of a transparent polymer layer to improve the multi-hit capacity of a window or as a blast protection layer for a window.

The spreading at high velocity of sharp (glass) fragments that may be ejected into an object such as a building or a vehicle from a blast of a nearby explosion is a major cause of injuries and casualties. The present invention provides a method that effectively avoids the fragments from being ejected or at least reduces the number of fragments being ejected, i.e. a transparent polymer layer as described herein may be used to provide protection against a detrimental effect of a blast. Thus, the invention may contribute significantly to reduce the number of casualties and injuries due to a blast, in particular from a bomb attack.

Further, the invention allows the window to resist the forces of the blast wave, in particular in case the polymer layer is attached to the remainder of the object, such as to a frame for the window or to a wall wherein the window is positioned.

Even if the window is broken in many fragments, the invention allows substantially all fragments to stay attached to the polymer instead of being ejected. This also protects people outside the object from spreading pieces of sharp glass fragments, such as glass fragments from the window of a building in which, or nearby which, an explosion occurred. Furthermore, the blast wave itself is prevented from entering the object, in case the explosion occurred outside the object. This further helps to prevent collateral damage and chaos inside the object.

The object may in particular be a building—such as an embassy or a bank—or a transportation device, in particular a vehicle, boat or plane.

The window provided with the polymer layer is transparent, preferably at least as transparent as water. The term “transparent” is generally understood in the art. It will be understood that transparency is to some extent dependent upon the thickness of the armour. In particular a material, such as the armour/pellet/matrix/backing material, is considered transparent if the luminous transmission is 85% or more and the haze is 5% or less.

The window may be a flat or curved panel, a screen, a canopy, a windshield, a visor, a dome, a glass door, a window in a door or the like. It is advantageous that the method of the invention can also easily be employed to a curved surface. For instance, armoured transportation devices, such as armoured cars, with special glass windows normally have flat windows. This makes the vehicles easily recognisable as armoured vehicles, which may cause aggression to adversaries of the people inside the vehicle in some circumstances, e.g. during peace keeping operations. When applied to a normal window, it is less noticeable that the vehicle is provided with a protection against an impact by a projectile.

In case a the window is a double glazing window, the polymer layer may conveniently be applied in a gap between an outer glazing of the window and an inner glazing of the window.

It is advantageous to improve an antiballistic property of the window in accordance with the invention by applying the polymer layer without detaching the window from the object. The layer can easily be applied whilst the window remains part of the object.

It has been found that also an antiballistic property of an ordinary window, made of a standard glass, for instance ordinary car glass can be improved in accordance with the invention. E.g. as shown in Example 1, a windscreen of a truck can be made resistant to the impact of projectiles from hand-guns, e.g. 9 mm bullets and fragments of a bomb, e.g. of about 1 g weight impacting at a velocity of about 1300 m/s.

The inventors have found that it is particularly advantageous with respect to improving the multi-hit capacity of the armour by providing the armour with a visco-elastic material. For improving multi-hit capacity, the visco-elastic relaxation time, preferably should be in the range of 10⁻⁹-10⁻¹ [s]. The hardness preferably is 70-100 Shore A

The polymer layer may in particular comprise one or more polymers selected from the group consisting of transparent acrylonitrile-butadiene-styrene; transparent acetal resins; transparent cellulose derivatives, in particular such cellulose esters, such as cellulose acetate, cellulose butyrate, cellulose propionate, cellulose triacetate and alkyl celluloses, such as ethyl cellulose; transparent acrylics, transparent allyl resins; transparent polyethers, in particular such chlorinated polyethers; transparent fluoroplastics; transparent melamines; transparent polyamides (nylon; transparent parylene polymers; transparent phenolics; transparent phenoxy resins; transparent polybutylene, transparent polycarbonates; transparent polyesters; transparent polyethylenes; transparent polypropylenes; transparent polyphenylenes; transparent polystyrenes, transparent polyurethanes; transparent polysulphones; transparent polyvinyl alcohols; transparent polyvinyl fluorides; transparent polyvinyl butyrals; transparent polyvinylidene chlorides, transparent silicones; transparent styrene acrylonitrides; transparent styrene butadiene; transparent polyvinylchlorides; including transparent copolymers of any of these.

Preferably the polymer layer comprises a polymer selected from the group consisting of transparent polyurethanes, transparent silicones, transparent polyvinylchlorides and transparent polycarbonates.

Particularly good results have been achieved with a transparent polyurethane, in particular with respect to transparency, (visco)-elastic properties and/or adherence to the surface of the window.

Suitable polyurethane resins for providing the polymer layer are commercially available. Examples thereof include: Castable transparent Polyurethane resin (PUR, such as ClearFlex hardness Shore A between 50 and 90, manufacturer Smooth-On, 2000 Saint John Street, Easton, Pa. 18042); MB International 438 PU; MB International Poly A80; Permapur RD 3505; Simula: SIM 2025, SIM 2003.

The mixture for providing the polymer layer preferably has a low viscosity, in particular a viscosity (at 25° C.) of 100 Pa·s or less.

The potlife of the mixture is the maximum period of time wherein the resin can be processed without substantially influencing the end result. The Potlife preferably is relatively long, in particular at least 25 min, e.g. 20-40 min.

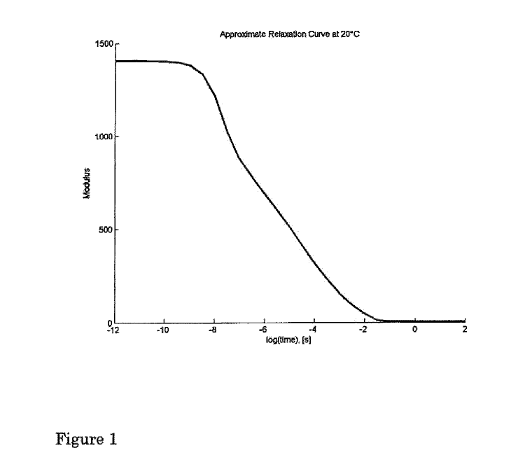

After curing, the polymer layer preferably meets one or more of the following criteria:
shrinkage (compared to uncured resin): 0.3% or less, in particular 0.15-0.3%.
elongation until rupture: at least 100%, in particular 175-500%
tensile strength: at least 2 MPa, in particular 2-20 MPa.
tear strength: at least 0.2 MPa, in particular 0.2-2 MPa.
hardness: at least Shore A 50, in particular Shore A 50-95.
Glassy (dynamic, 1 Hz) Young's modulus: about 2700 MPa.
Rubber (dynamic, 1 Hz) Young's modulus: about 4.5 MPa
glass transition temperature about 20+5° C.
a relaxation curve as measured by the method described in ° C. van 't H of, Mechanical Characterization and Modeling of Curing Thermosets, PhD thesis Delft University of Technology, 2005, essentially corresponding to the curve shown in FIG. 1.

Tear strength may be determined according to ISO 34, Hardness according to ISO 868, parameters obtainable by a tensile test according to ISO 35.

Optionally, the polymer layer comprises one or more additives in order to alter a mechanical property, adherence to the surface of the window and/or transparency.

The window may in principle be composed of any transparent material suitable for a window. Usually it is a glass material suitable for a normal use in a particular object, such as normal glazing for a building.

In particular, the window may be composed of a glass selected from tempered glass, layered glass, or a normal glazing for a vehicle or a building.

The thickness of the window to be armoured may be within a usual range for a window in the specific object. In general, the thickness may be in the range of 2 to 15 mm. In particular, the thickness of a window in a vehicle may be 3 to 7 mm. The thickness of a window in a building may in particular be in the range of 4 to 12 mm.

Preferably, the surface of the window may be cleaned before applying the layer. It is in particular desired to remove dust and/or grease, if present on the surface.

The polymer layer is preferably at least applied at a surface opposite the surface from which a thread is expected, so usually to a surface of the window facing the inside of the object. Thus, a projectile impacting on the window would first hit the surface of the window opposite of the polymer layer, deform the projectile, and locally tear or even shatter at least to some extent. The polymer layer at the other surface is particular suitable to substantially reduce the degree of tearing or shattering and/or avoiding spreading of fragments of the glass, which is also relevant for blast protection.

The polymer layer may be applied while the material for forming the layer is fluid, e.g. by brushing or casting, after which the material is allowed to solidify. Solidification may be carried out in a manner known in the art per se, for the specific material. Specific material properties, such as elasticity or visco-elasticity, ductility etc. may be controlled by the choice of components and ratio from which the layer is composed, such as chemical structure and average polymer weight of the polymer and/or the presence of a cross-linking agent.

In order to avoid flowing of the fluid polymer or polymer composition over or from the surface before it has sufficiently solidified, the fluid polymer may be held in between the surface of the window and a rigid support, e.g. a glass or metal plate. In order to avoid sticking of the polymer layer to the support, the support may be pre-treated with an anti-adhesive for the polymer layer, generally known as release agent, e.g. polytetrafluorethylene (such as Teflon®). After sufficient solidification of the polymer layer, the support is removed.

For ease of application, it is preferred to first prepare a polymer sheet with the desired thickness and properties which is thereafter adhered to the window. The sheet can be prepared on a large scale in a factory and thereafter anywhere applied to the window of the object. Thus, the person actually applying the polymer layer to the window needs not to be skilled to prepare polymer layers from base materials. Also, this it is easier to control the thickness of the polymer layer and its properties such as mechanical properties and transparency.

The sheet may be adhered to the surface of the window using a suitable adhesive, for instance a polyurethane adhesive and/or a polyvinylbutyral adhesive.

The thickness of the layer can be chosen within wide limits, depending upon the mechanical properties of the layer, the desired improvement in an antiballistic property, and practical reasons such as the maximum possible or desired thickness of the window including polymer layer in view of aesthetic considerations and/or the functioning of the object.

For improving an antiballistic property, the thickness of the layer is usually at least 5 mm, preferably at least 10 mm, more preferably at least 15 mm. Particular results have been achieved with a layer having a thickness of 20 mm or more.

For practical reasons, such as mass limitation, the thickness is generally 40 mm or less, preferably 30 or less, in particular in a transport, such as a car, a bus, a truck or an aircraft.

If desired, the side of the polymer layer opposite to the window to which it is attached, may be provided with a transparent plastic sheet to improve smoothness of the layer, in particular in case the polymer layer is sticky and/or to protect the layer from being damaged during normal use. Such sheet can be relatively thin, in particular 1 mm or less, e.g. 0.1-1 mm. A particularly suitable sheet is a transparent polyearbonate sheet.

The invention will now be illustrated by the following examples.

### EXAMPLE 1

### PUR Casting Process

The inner surface of the windscreen (a layered glass construction with a total thickness of 6.6 mm) was cleaned using water and soap and finally with acetone.

Then the area to be protected was surrounded by a 4 cm high strip of polyethylene which was watertight connected to the glass surface (by waterproof tape or an elastomeric strip).

The right amount of components A (polyol) and B (isocyanates) of the Smooth-on product Clear Flex were mixed in the required mass ratio (100:175) by mechanical stirring in a mixing container (polyethylene). After 5 minutes of active mixing the container is vacuumized for 2 minutes in order to remove entrapped air from the mixture.

Then the mixture was gently applied onto the glass surface in a corner of the area to be covered. Then the mixture reacted and hardened as well as bonded to the glass surface, the hardness of the PUR layer was measured as Shore A 75.

### EXAMPLE 2

### PUR Plate Fabrication and Adhesion Process

A simple rectangular watertight container or box was made from aluminum plate material (size 200×300×40 m, then the die was internally covered with PE-plates. PE does not adhere to polyurethane resin (PUR).

Enough of the PU mixture (components A and B in the required mass ratio) was made in the same way as described above and poored into the PE covered die.

The mixture reacted and cured in the container in the form of a flat plate. The container walls were removed and the PUR plate was taken away from it.

The inner surface of a car door window was cleaned using water, soap and acetone. The side window of a car exists of a single layer of tempered glass. Its thickness was 4.9 mm. A small amount of PUR mixture was made in the right amount of components A (polyol) and B (isocyanates) of the Smooth-on product Clear Flex are mixed in the required mass ratio (100:150) by mechanical stirring in a plastic cup.

After vacuumizing this mixture, a small amount is poored on the inner glass surface. The PUR plate was carefully layed on top of the horizontal positioned glass, taking care that no air bubbles were entrapped between the glass and the PUR. The PUR plate was mechanically pressed onto the glass using a mass divided over its surface (using a powder inside a bag).

After 12-24 hours the resin cured and the PUR-plate was well bonded to the glass.

Ballistic Testing

The ballistic tests on the flat glass objects with and without the PUR backing layers have been performed using steel fragment simulating projectiles (FSP) with a mass of 1.1 gram. Its impact velocity on the glass layer could be controlled. The V50 corresponds to a velocity of the FSP that upon perpendicular impact to the target has a 50% chance to penetrate the target material.

First the windscreen was tested without a PUR backing layer and the V50 of the 1.1 gram FSP was determined to be 300 m/s. The same windscreen was shot using a fire-arm projectile (9 mm Ball DM41) with an impact velocity of 427 m/s, which easily penetrated the glass as its residual velocity was still high (339 m/s).

Then the area of the windscreen that had a 20 mm thick PUR backing layer (shore A 75) was tested.

The V50 of the polymer backed windscreen was increased to 1300 m/s using the 1.1 gram FSP. Also this protected area was shot using the 9 mm Ball DM 41 bullet with an impact velocity of 433 m/s. The bullet did not penetrate the target and was recovered heavily deformed at the glass/polymer interface. The glass layer was heavily damaged in an area with a radius of 3 cm around the impact site. Also some longer cracks were visible in one layer of the (two-layered) glass. The polymer layer was not broken or fractured and was still transparent.

The ballistic properties of the car door window were measured by V50 determination using the 1.1 gram FSP as well.

The unprotected tempered glass has a V50 of about 240 m/s (less then the windscreen due to its reduced glass thickness). Due to its internal stress (which is normal in tempered glass) the glass fragmented totally in many small pieces.

The PUR backed car door window using adhesion of the PUR-layer showed an increased ballistic protection of its V50 value to 940 m/s. Also in this case did the glass fragment totally, however the fragments remained adhered to the PUR backing layer. This allowed the window to stop also following (multiple) FSP impacts.

### EXAMPLE 3

### Blast Protection for a Window

Rectangular glass panels (90×70 cm) with a thickness of 8 mm were prepared in order to increase their level of protection against blasts by attachment of a layer of a transparent polymer at the inner side (opposite to side at which the blast wave acts).

The thickness of this layer ranged from 5 to 10 mm and the polymer was optically water clear (very transparent). Two ways to prepare the windows were considered:
A prefabricated polymer backing layer may be attached to the glass panel using a transparent adhesive.
The backing layer may be applied by pouring a resin on top of the (horizontally positioned) glass panel.

Herein, the second option was used, to show proof of principle. The glass panels were cleaned using soap and water. After drying, the panel was placed on a table horizontally, making sure that its surface was leveled. Then a blend of the two component transparent polyurethane ClearFlex 75 was mechanically mixed in a ratio of 100:175 (Component A; Component B). The mass of this resin mixture was adjusted to the thickness of the backing layer to be obtained.

The resin was allowed to harden for at least 12 hours before the glass panel was removed from the table. The hardness of the transparent backing layer was measured to be 18 Shore D. At this hardness level the polymer has good mechanical properties such as tensile strength and ductility.

Blast Test

The panels were positioned as a window frame in a steel wall at the end of a blast tunnel. Within the tunnel a reactive (acetylene/oxygen) gas mixture or an explosive charge could be ignited. The detonation within the tunnel created a focused blast wave directed towards the steel wall and hence the window. The response of the panels was recorded by two high speed video cameras. Also pressure profiles were measured both 1.5 meter before the wall and the reflected blast wave on the wall inside the blast tunnel.

Initial experiments (using both the reactive gas mixture as well as 175 grams of C4 explosives) made use of bare glass panels which demonstrated that the unprotected glass itself responded on the blast wave by breaking in many sharp fragments that were ejected with high velocity out of the tunnel.

The same happened to glass panels that were backed by a ballistic foil. The sharp fragments simply perforated the foil which therefore could not avoid the glass fragments from being ejected out of the tunnel.

Then the first test was done using a glass panel with a backing layer of 10 mm Clearflex 75. The same explosive gas mixture was used as before on the unprotected glass layer (28 liter of a 1:2.5 Acetylene/oxygen mixture). The peak pressure of the initial blast wave was measured to be 31 kPa, while it was 79 kPa on reflection at the wall.

From the high speed video images the response of the window was obtained. At first the panel bended outward from the tunnel, then returned by bending into the tunnel. As the panel did not break, the blast wave was reflected back into the tunnel and returned as a second blast wave after reflecting at the closed opposite side of the blast tunnel. Also a third blast wave could be seen to load the glass panel.

By this time the wooden window frame had broken down which gave way to the panel that eventually escaped from the window frame. It was found not far from the exit of the tunnel and showed the glass fragments still attached to the practically intact polymer backing layer.

In a second test again a panel with 10 mm of Clearflex 75 was used in a new wooden window frame. This time an explosive mass of 175 gram C4 (just as was used before on tests with the unprotected glass panels) was used inside the blast tunnel. The peak pressure of the blast wave was measured to be 45 kPa before the wall, and 87 kPa on reflection at the wall.

The response of the window was largely the same as in the previous experiment. Also in this case the window frame broke, although this happened only on one side of the frame. This resulted in the fact that the glass panel remained attached to the wall, although it was detached on one side, resulting in the opening of the window. Practically all glass fragments remained attached to the backing polymer layer, and only a few fragments were missing after the experiment.

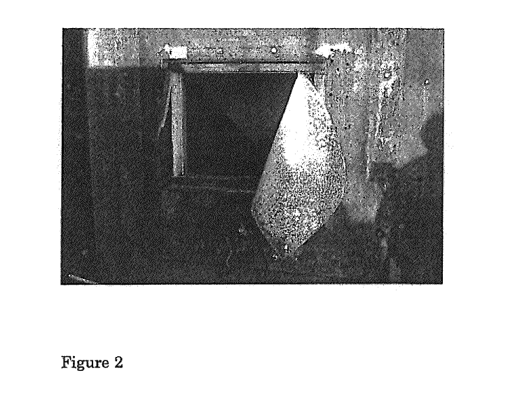

FIG. 2 shows the glass panel provided with a blast protective layer, after blast loading in the blast tunnel. The wooden window frame broke on one side (left) which opened the glass panel, however the glass fragments remained attached to the polymer backing layer.

A third experiment was performed using a 5 mm thick backing layer of Clearflex 75 in a wooden frame. Again the explosive gas mixture (28 litre of a 1:2.5 Acetylene/oxygen mixture) was used. The peak pressure of the initial blast wave was measured to be 31 kPa, while it was 75 kPa on reflection at the wall.

Also in this experiment the window frame broke as the blast wave on the protected glass panel generated to large forces to the wooden window frame. The panel was therefore no longer held in position and was thrown away from the tunnel opening. Most of the glass fragments still adhered to the backing layer.

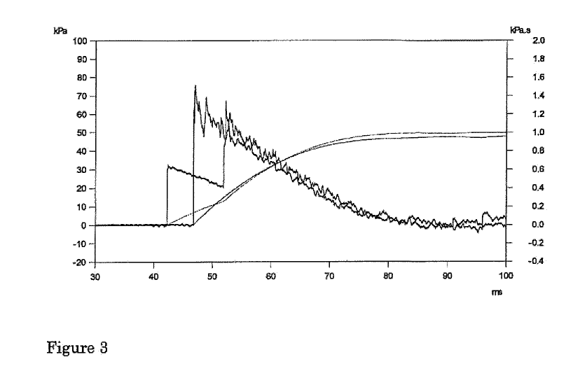

FIG. 3 shows pressure plots (taken 1.5 m before the wall and at the wall) as well as impulse plots of the blast tunnel experiment using an explosive gas mixture. The time frame of the pressure plot shown in FIG. 3 is too short to show the reflected blast waves within the tunnel. The reflected blast waves form a higher load on the window compared to an explosive event outside, as outside explosions normally do not result in blast reflections, or if blast reflections occur it all, these generally occur at much lower intensity and number.

The fact that in all cases the window frame broke while using protected glass panels, while all the unprotected glass panels broke in many fragments without damaging the window frame, demonstrates that the backing layer transfers the forces (impulse) of the blast wave to the window frame. The wooden window frames were not strong enough to survive the blast loads, resulting in the ejection of the protected glass panel.

However, practically all glass fragments remained attached to the backing layer which demonstrates that it is possible to avoid sharp glass fragments being thrown inside by a blast wave hitting a window. Using a stronger (or reinforced) window frame it is possible not only to avoid the glass fragments from being ejected into a building, but also to prevent the blast wave from entering the building. Since the fragments remain attached to the backing layer, also people outside are prevented from being hit by glass fragments.

### EXAMPLE 4

### PUR Casting Process

The ballistic properties of an existing typical insulating window of a building, consisting of two glass layers (having a thickness of 5 mm, respectively 4 mm) separated by a 15 mm gas filled gap using a metal frame, was enhanced by filling the gap with a transparent PUR.

A hole was drilled in the upper and lower side of the frame.

The right amount of components A (polyol) and B (isocyanates) of the Smooth-on product Clear Flex were mixed in the required mass ratio (100:175) by mechanical stirring in a mixing container (polyethylene). After 5 minutes of active mixing the container was vacuumized for 2 minutes in order to remove entrapped air from the mixture.

Then the window was placed with the lower frame side in the mixture, while an air pump lowered the gas pressure between the glass layers through the hole in the upper side of the frame. Due to the pressure difference between the gas inside and outside the gap between the glass layers, the mixture flowed gently into the gap until the frame was filled completely.

Then the mixture reacted and hardened as well as bonded to the glass surfaces, the hardness of the PUR layer was measured as Shore A 75.

1. Method for armouring a window of an existing object comprising applying a transparent polymer layer to a surface of the window, wherein the strength of the polymer layer is at least 2 MPa and the thickness of the polymer layer is at least 5 mm.

2. Method according to claim 1, wherein the layer is applied to a surface facing the inside of the object.

3. Method according to claim 1, wherein a transparent ductile polymer sheet is adhered to the surface.

4. Method according to claim 1, wherein the polymer layer is an elastic or visco-elastic layer.

5. Method according to claim 1, wherein a fluid polymer or fluid polymer composition is applied to the surface, which polymer or polymer composition is thereafter allowed to cure.

6. Method according to claim 5, wherein after applying the polymer or polymer composition, a transparent sheet is applied to the surface of the polymer layer.

7. Method according to claim 1, wherein the ductile polymer layer comprises a visco-elastic polymer.

8. Method according to claim 1, wherein the polymer layer comprises one or more polymers selected from the group consisting of transparent acrylonitrile-butadiene-styrene; transparent acetal resins; transparent cellulose derivatives, in particular such cellulose esters, such as cellulose acetate, cellulose butyrate, cellulose propionate, cellulose triacetate and alkyl celluloses, such as ethyl cellulose; transparent acrylics, transparent allyl resins; transparent polyethers, in particular such chlorinated polyethers; transparent fluoroplastics; transparent melamines; transparent polyamides (nylon; transparent parylene polymers; transparent phenolics; transparent phenoxy resins; transparent polybutylene, transparent polycarbonates; transparent polyesters; transparent polyethylenes; transparent polypropylenes; transparent polyphenylenes; transparent polystyrenes, transparent polyurethanes; transparent polysulphones; transparent polyvinyl alcohols; transparent polyvinyl fluorides; transparent polyvinyl butyrals; transparent polyvinylidene chlorides, transparent silicones; transparent styrene acrylonitride; transparent styrene butadienes; transparent polyvinylchlorides; and transparent copolymers of any of these.

9. Method according to claim 1, wherein the window is composed of a glass selected from the group consisting of single layer tempered or single-layer untempered glass, layered glass, vehicle glazings, boat glazings, plane glazings, and building glazings

10. Method according to claim 1, wherein the object is selected from buildings, counters and transports, in particular from vehicles, boats, planes, banks and embassies.
